(19) United States
(12) Patent Application Publication
(10) Pub. No.: US 2024/0403695 A1
(43) Pub. Date: Dec. 5, 2024

(54) SEEDING/MAINTAINING HEAD MACHINE LEARNING MODELS

(71) Applicant: NCR Corporation, Atlanta, GA (US)

(72) Inventors: German Capuano, Tucker, GA (US); Joseph Hetherington Deerin, Atlanta, GA (US); Matthew K. Farrow, Canton, MA (US)

(21) Appl. No.: 18/204,271

(22) Filed: May 31, 2023

(51) Int. Cl. G06N 20/00

(52) U.S. Cl. CPC G06N 20/00

(57) ABSTRACT

A root machine learning model receives an item image captured of an item at a terminal and produces output, which is associated with an item classification for the item. A head machine learning model is selected from a plurality of head models based on transaction information associated with a transaction at a terminal. A candidate item identifier is received from the terminal. The head model uses the candidate item identifier, the root model's output data, and localized metadata maintained for the head model to provide a predicted item identifier for the item. An actual item identifier for the item is received as feedback from the terminal. The localized metadata is updated with the root model's output data and the actual item identifier for the item based on the feedback.

### BACKGROUND

The use of machine learning models has increased in recent years due to the need for more accurate and efficient image classification. However, training these models with a large set of training images can be challenging due to the high dimensionality of the data. This can lead to lower performance or poorer accuracy in the models when new data is presented.

### SUMMARY

In various embodiments, a system and methods for seeding and maintaining a head machine learning model is presented. A root machine learning model (herein after “root model”) receives an item image captured of an item at a terminal and produces a coarse grain feature vector, which is associated with an item classification for the item, as output. Transaction information for a transaction at a terminal is obtained and based on the transaction information a head machine learning model (hereinafter “head model”) is selected from a plurality of head models.

A candidate item identifier is received from the terminal. The head machine learning model uses the candidate item identifier, output from the root model, and localized metadata maintained for the head model to provide a predicted item identifier for the item. An actual item identifier for the item is received as feedback from the terminal and the localized metadata is updated with the output from the root model, the actual item identifier, and transaction information associated with the transaction based on the feedback.

### BRIEF DESCRIPTION OF THE DRAWINGS

FIG. 1 is a diagram of a system for seeding and maintaining a head machine learning model, according to an example embodiment.

FIG. 2 is a flow diagram of a method for seeding and maintaining a head machine learning model, according to an example embodiment.

FIG. 3 is a flow diagram of another method for seeding and maintaining a head machine learning model, according to an example embodiment.

### DETAILED DESCRIPTION

A root machine learning model (“root model” and/or “root MLM”) is an efficient way of obtaining a coarse grain classification for an item image. The root model is trained on a large data set of item images such that when an item image is provided during a transaction at a terminal to the root model. The root model quickly and efficiently returns a coarse grain classification for the corresponding item. However, it is challenging to achieve granular item identification using just the root model. This is because each retail store can use different item identifiers for their items. For example, price lookup (PLU) codes for produce items often vary from store to store.

Consequently, training a root model on each store's specific exceptions would be infeasible because an already large training data set would have to be substantially increased to account for each store's unique situation, resulting in the root model being highly dependent on the training data and poorly performing against unseen item data. Essentially, the root model struggles to map a same item that is to be mapped to multiple different item codes associated with multiple different stores.

The teachings provided herein address these issues and provide an accurate item identifier for an item image during a transaction at a terminal. This is done by using feature vectors produced by a root model in classifying item images as seeds to head machine learning models (“head modules” and/or “head MLMs”). A plurality of head models are dynamically maintained without any manual intervention being required. During a given transaction at a given terminal, an appropriate head model is selected to receive a seed feature vector and/or root model output. A customer or operator of the terminal uses the terminal's transaction interface to enter a candidate item identifier for an item. The selected head model takes the seed feature vector or root model output, the candidate item identifier, and localized metadata that is unique to the selected head model and produces as output a predicted item identifier for the item image. When the operator provides an actual identifier for the item during the transaction, the localized metadata is updated to include the seed feature vector or root model output, and transaction information, such as and by way of example only, retailer identifier, store identifier, terminal identifier, customer identifier, etc. In an embodiment, the localized metadata may be updated either whenever an actual item identifier is entered, or only when the actual item identifier does not match the predicted item identifier (in which case the localized metadata is not updated when the actual item identifier matches the predicted item identifier). As a result, the f1 and accuracy of the selected head model is continuously improved each time the select head model provides a predicted item identifier.

Furthermore, each of the customized head models are trained on far less data than what is conventionally required; however, the training data is far more specific and accurate. In an embodiment, the feature dimensions, which are present in the seed feature vectors or root model outputs are prioritized by each of the head models in their localized metadata, which is automatically updated and/or tuned as transactions are processed at terminals.

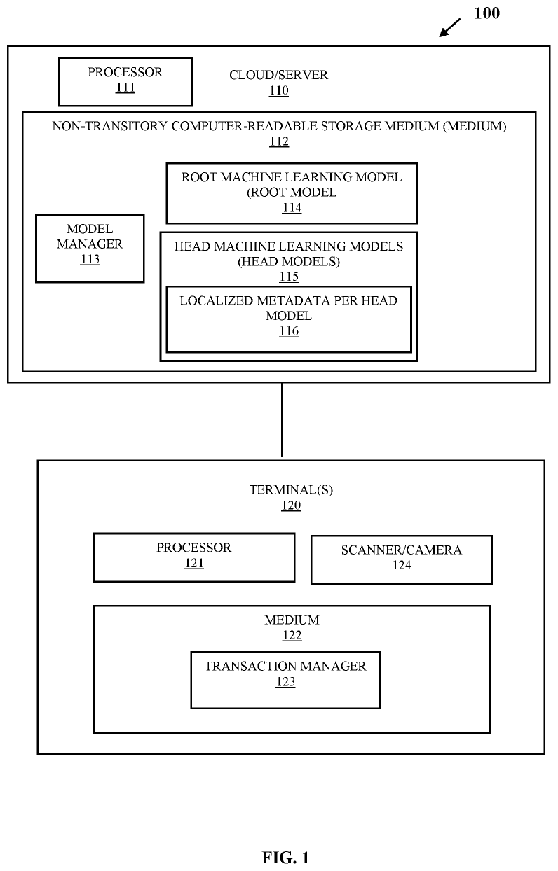

FIG. 1 a is a diagram of a system 100 for seeding and maintaining localized head models, according to an example embodiment. It is to be noted that the components are shown schematically in greatly simplified form, with only those components relevant to understanding of the embodiments being illustrated.

Furthermore, the various components illustrated in FIG. 1 and their arrangement is presented for purposes of illustration only. It is to be noted that other arrangements with more or less components are possible without departing from the teachings of seeding and maintaining localized head models as presented herein and below.

The system includes a cloud 110 or a server 110 (herein after just “cloud 110”) and a plurality of terminals 120. Cloud 110 includes a processor 111 and a non-transitory computer-readable storage medium (herein after just “medium”) 112, which includes executable instructions for a model manager 113, a root model 114, and a plurality of head models 115. Each head model 115 further includes localized metadata 116.

Each terminal 120 includes a processor 121 and medium 112, which includes executable instructions for a transaction manager 123. Each terminal 120 further includes a scanner/camera 124 to capture at least one image of an item during a transaction at the corresponding terminal 120.

Root model 114 is trained on a plurality of item images for items. This includes a plurality of items of each item. The root model 114 is trained to produces as output an item classification feature vector, seed item classification vector, or other root model output that includes a plurality of identified features along with a probability representing a degree to which a each feature was significant in determining the predicted item classification. The features represent dimensions associated with visual attributes identified in a given item image, such as and by way of example only, colors, shape, lines, edges, dimensions, packaging, etc. The data sets of item images used for training root model 114 spans multiple different retail stores and/or multiple different retailers across a large geographical area. As a result, any item classification feature vector or root model output provided from the root model 114 includes a large number of feature dimensions and is coarse grain.

Model manager 113 provides the feature vectors produced by the root model 114 as an input to a selected head model 115 as a seed or as a seed item classification feature vector. Model manager 113 selects a given head model 115 based on any number of factors, such as a store identifier associated with a store, a terminal identifier associated with a given terminal 120, a department within a store where the a given terminal 120 is known to reside, a geographic region of the store, a customer identifier for a customer, etc.

In an embodiment, model manager 113 maintains one or more hierarchies to which the head models 115 are linked. Model manager 113 uses known transaction information provided by the terminal 120 during a transaction to traverse the hierarchy and select a given head model 115. For example, the hierarchies are maintained per geographical region, per retailer, per store, etc.; the transaction information identifies a retailer, a store, a department, the terminal 120, and/or a customer associated with the transaction. In this example, model manager 113 maps a store identifier to a geographical location and traverses a given hierarchy with remaining portions of the transaction information to locate and to identify a specific head model 115 to process for the transaction based on the retailer, the store, the department, the terminal 120, and/or the customer.

Each head model 115 is trained on labeled input that includes a seed item classification vector or root model output and an operator-provided candidate item identifier for a given labeled known item. Following training the corresponding head model 115 has created unique localized metadata, which head model 115 relies on to provide predicted item identifiers. In an embodiment, the localized metadata 116 is a heuristic table that includes, by way of example only, the seed item classification vectors received from the root, averages of seed item classification vectors, moving averages of the seed item classification vectors, probabilistic moving averages of the seed item classification vectors, ranges of seed item classification vectors, specific feature-based probabilities/weights, item purchase statistics, terminal purchase statistics, calendar dates, days of week, times of day, known holiday dates, department purchase statistics, customer-specific purchase statistics, and item identifiers for items of a store associated with a given terminal. Each head model 115 processes its localized metadata 116 using a provided seed item classification vector or root model output and an operator-provided candidate item identifier to resolve a predicted item identifier during any given transaction at a given terminal 120.

Following training of a given head model 115, the head model receives a seed item classification vector or root model output, an operator-provided candidate item identifier, and relies on or processes its existing localized metadata to produce a predicted item identifier. In making any given prediction, the head model 115 can update the localized metadata 116.

During a given transaction at a given terminal 120, an item image is captured of an item placed on a weigh scale of a combined scanner/scale 124. Camera 124 captures the image and makes the item image accessible through a monitored network location or provides the item image to model manager 113. Transaction manager 123 simultaneously provides transaction information for the transaction to model manager 113. Model manager 113 provides the item image to root model 114 and receives a corresponding seed item classification vector or root model output. Model manager 113 selects an appropriate head model 115 based on the transaction information for the transaction.

The transaction information provided by manager 123 also includes a candidate item identifier for the item; the candidate item identifier is provided by either transaction manager 123 when a scanner 124 scanned an item barcode off the item or provided by an operator that manually entered the candidate item identifier. When the operator provides the candidate item identifier, the item is likely, but not always, associated with a produce item for which the transaction manager 123 needs a PLU code is for the transaction.

Model manager 113 provides the seed item classification vector or root model output and the candidate item identifier to the selected head model 115 and receives as output a predicted item identifier for the item based on the head model's localized metadata 116. Model manager 113 provides the predicted item identifier back to transaction manager 123. Manager 123 records the predicted item identifier with the transaction when the candidate item identifier matches the predicted item identifier.

In an embodiment, when the candidate item identifier does not match the predicted item identifier, manager 123 displays a model image of the item associated with the predicted item identifier to the operator of terminal 120 through the transaction interface and requests that the operator confirm that the displayed item is what the operator intended to enter instead of the candidate item identifier. When the operator insists through a selection that the item is associated with the candidate item identifier, manager 123 requests an intervention and suspends the transaction from completing until an attendant is dispatched to the terminal 120 to verify the item that the operator has.

Continuing with the latter embodiment, the attendant can either select the item from an override transaction interface as being associated with the candidate item identifier, the predicted item identifier, or a completely different item identifier. When the attendant overrides the predicted item identifier to be the candidate item identifier or the different item identifier, transaction manager 123 reports the change back to model manager 113. Model manager 113 uses the changed item identifier to update the selected head model's localized metadata 116. This causes the head model 115 to update is item predictions, which are based on its localized metadata 116, because of the changed item identifier updated in the localized metadata 116.

In an embodiment, even when the actual item identifier is the predicted item identifier, model manager 113 updates the corresponding localized metadata 116 to include the seed item classification vector or root model output, the actual item identifier, a retailer identifier for the retailer, a terminal identifier for the terminal, and/or a store identifier for the store.

As a result, each head model 115 is continuously tuned in real-time as its localized metadata 116 is updated by model manager 113. This improves f1 and/or accuracy of each of the head models 115 without manual retraining and without manual maintenance.

One now appreciates how head models 115 are seeded, trained, automatically updated, automatically tuned, and automatically maintained without manual intervention. Moreover, the f1 values of the head models 115 in predicting item identifiers for items are improved over time based on the individual transaction environments associated with each of the head models 115. The level of granularity associated with the head models 115 is configurable such that any given head model is specific to a retailer, specific to a store of the retailer, specific to a customer of a retailer, specific to a department of a store, etc. Furthermore, the head models 115 are arranged in hierarchies for selection of a specific head model 115 needed for a given transaction at a given terminal 120. A single root model 114 is trained and maintained for the head models 115.

In an embodiment, instead of manager 123 suspending the transaction for an attendant intervention, manager 123 relies on a second confirmation from the operator that the item is the candidate item identifier. Manager 123 can be configured to permit this reconfirmation when a difference in price between the candidate item identifier and the predicted item identifier is within a threshold price difference. In this embodiment, manager 123 can be configured to report the discrepancy back to the model manager 113 or ignore and not report the discrepancy, such that modifications are made or are not made to the head model's localized metadata 116 based on the reconfirmation by the customer.

In an embodiment, terminal 120 is a self-service terminal (SST) or a point-of-sale (POS) terminal. In an embodiment, the operator of the terminal 120 is a customer when the terminal 120 is an SST. In an embodiment, the operator of the terminal 120 is a cashier when the terminal 120 is a POS terminal.

In an embodiment, each head model 115 is embedded in a corresponding terminal 120 and processes on that terminal 120. In an embodiment, the root model 114 and a corresponding head model 115 is embedded in terminals 120 and process on that terminal 120; the root model 114 is deployed as different instances of a same model on the terminals 120 whereas each terminal includes a different head model 115. In an embodiment, the processing associated with the model manager 113 is subsumed within and processed on the terminals 120.

In an embodiment, the root model 114 and/or is trained on multiple images captured of an item during a transaction. That is, multiple images from different angles and/or present in different image frames for a single item are passed as input to root model 114.

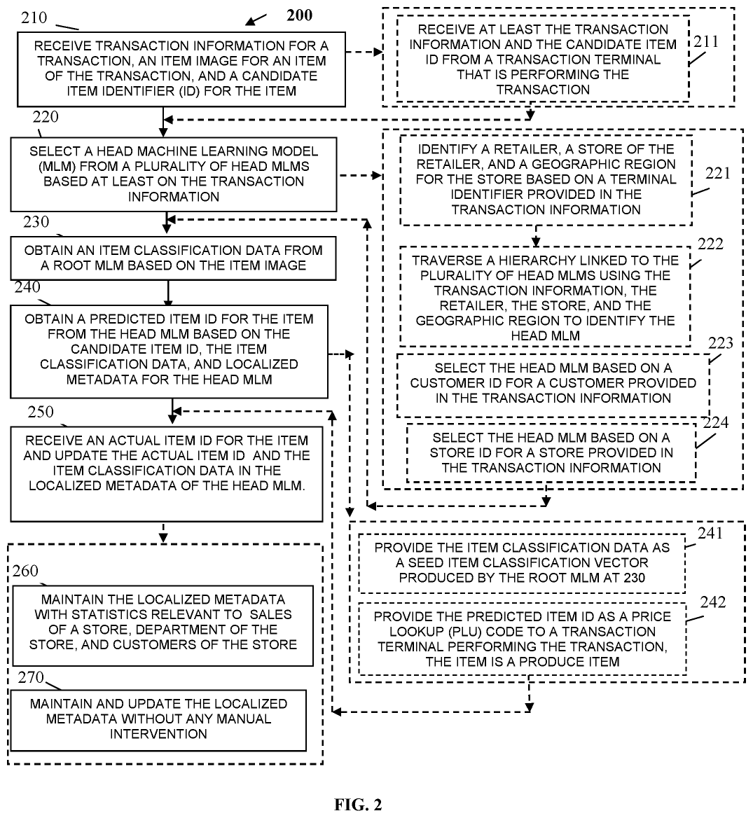

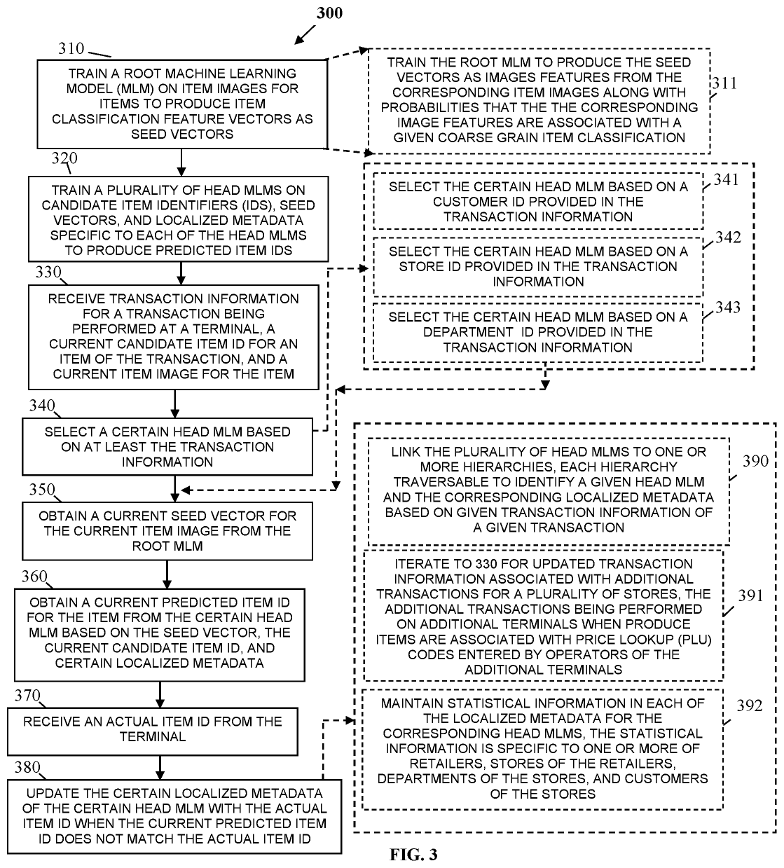

The above-referenced embodiments and other embodiments are now discussed with reference to FIGS. 2 and 3. FIG. 2 is a flow diagram of a method 200 for seeding and maintaining a head machine learning model, according to an example embodiment. The software modules(s) that implements the method 200 is referred to as a “head model manager.” The head model manager is implemented as executable instructions programmed and residing within memory and/or a non-transitory computer-readable (processor-readable) storage medium and executed by one or more processors of one or more devices. The processor(s) of the device(s) that executes the head model manager are specifically configured and programmed to process the head model manager. The head model manager has access to one or more network connections during its processing. The connections can be wired, wireless, or a combination of wired and wireless.

In an embodiment, the device that executes the head model manager is cloud 110 or server 110. In an embodiment, server 110 is a server of a given retailer that manages multiple stores, each store having a plurality of terminals 120. In an embodiment, terminal 120 is an SST or a POS terminal. In an embodiment, the head model manager is some, all, or any combination of, model manager 113, root model 114, and/or head models 115 include corresponding localized metadata 116.

At 210, head model manager receives transaction information for a transaction, an item image captured for an item of the transaction, and a candidate item identifier for the item. The transaction information includes, by way of example only, a variety of information such as a terminal identifier for the terminal, a transaction identifier for the transaction, a current date, a current time of day, a department identifier for a department associated a terminal where the transaction is being performed, a customer identifier for a customer associated with the transaction, a store identifier associated with a store of the transaction, a retailer identifier for a retailer associated with the store, etc.

In an embodiment, at 211, the head model manager receives at least the transaction information and the candidate item identifier from a transaction terminal 120. The terminal 120 is performing the transaction in real time and the terminal being operated by a customer of the transaction or a cashier.

At 220, the head model manager selects a head model 115 from a plurality of head models 115 based at least on the transaction information. The selection of the head model 115 includes a variety of options.

For example, at 221, the head model manager identifies a retailer, a store of the retailer, and a geographical region for the store based on a terminal identifier provided in the transaction information. In an embodiment of 221 and at 222, the head model manager traverses a hierarch linked to the plurality of head models 115 using the transaction information, the retailer, the store, and the geographic region to identify and select the head model 115.

In an embodiment, at 223, the head model manager selects the head model 115 based on a customer identifier for a customer provided in the transaction information. In an embodiment, at 224, the head model manager selects the head model 115 based on a store identifier for a store provided in the transaction information.

At 230, the head model manager obtains item classification data from a root model 114 based on the item image. That is, the item image is provided as input to the root model 114 and the root model 114 returns the item classification data as output.

At 240, the head model manager obtains a predicted item identifier for the item from the head model 115 based on the candidate item identifier, the item classification data, and localized metadata 116 for the head model 115. In an embodiment, at 241, the head model manager provides the item classification data to the head model 115 as a seed item classification vector produced by the root model 114. In an embodiment, at 242, the head model manager provides the predicted item identifier as a PLU code to terminal 120; the item is a produce item and lacks any barcode or item code.

At 250, the head model manager receives an actual item identifier for the item from the terminal 120 and head model manager updates at least the actual item identifier and the item classification data within the localized metadata 116. The set of features, statistics, etc. within the localized metadata 116 that caused the head model 115 to provide the predicted item identifier is modified such that the set of features, statistics, etc. would cause the head model 115 to provide the actual item identifier when the item classification data is provided a second time to the head model 115. This is essentially a modified and enhanced form of continuous training of the head model 115, which is efficient and effective.

In an embodiment, at 260, the head model manager maintains the localized metadata 116 with statistics relevant to sales of a store, department of the store, and customers of the store. In an embodiment, at 270, the head model manager maintains and updates the localized metadata 116 without any manual intervention being required.

FIG. 3 is a flow diagram of a method 300 for seeding and maintaining a head machine learning model, according to an example embodiment. The software module(s) that implements the method 300 is referred to as a “model manager.” The model manager is implemented as executable instructions programmed and residing within memory and/or a non-transitory computer-readable (processor-readable) storage medium and executed by one or more processors of one or more devices. The processor(s) of the device(s) that executes the model manager are specifically configured and programmed to process the model manager. The model manager has access to one or more network connections during its processing. The connections can be wired, wireless, or a combination of wired and wireless.

In an embodiment, the device that executes the model manager is cloud 110 or server 110. In an embodiment, server 110 is a server of a given retailer that manages multiple stores, each store having a plurality of terminals 120. In an embodiment, terminal 120 is an SST or a POS terminal. In an embodiment, the model manager is some, all, or any combination of, model manager 113, root model 114, head models 115 including the corresponding localized metadata 116, and/or method 200. In an embodiment, the model manager presents another, and in some ways, an enhanced processing perspective to that which was discussed above with method 200 of FIG. 2.

At 310, model manager trains a root model 114 on item images for items to produce item classification feature vectors as seed vectors processed by head models 115. The item classification vectors are associated with coarse grain item classifications. The root model 114 is a single model that provides seed vectors processed by a plurality of head models 115. The root model 114 is trained on a plurality of item images for each item.

In an embodiment, at 311, the model manager trains the single root model 114 to produce the seed vectors as image features from the corresponding item images along with probabilities that the corresponding image features are associated with a coarse grain item classification. The total number of different available features for all of the item classifications represents a total number dimensions identified and used by the root model 114.

At 320, the model manager trains a plurality of head models 115 on candidate item identifiers, the seed vectors, and localized metadata 116 specific to each of the head models 115 to produce predicted item identifiers. In an embodiment, the localized metadata 116 is a heuristic table processed by a corresponding head model 115 in connection with a corresponding seed vector and candidate item identifier to provide a given predicted item identifier.

At 330, the model manager receives transaction information for a transaction being performed at a terminal 120, a current candidate item identifier for an item of the transaction, and a current item image for the item. The current item image is input to the single root model 114 to provide a current seed vector.

At 340, the model manager selects a certain head model 115 based on at least the transaction information. In an embodiment, at 341, the model manager selects the certain head model 115 based on a customer identifier provided in the transaction information. In an embodiment, at 342, the model manager selects the certain head model 115 based on a store identifier provided in the transaction information. In an embodiment, at 343, the model manager selects the certain head model 115 based on a department identifier provided in the transaction information.

At 350, the model manager obtain a current seed vector for the current item image from the single root model 114. The single root model 114 is processed to provide seed vectors for each of the plurality of head models 115 regardless of which head model 115 is selected by the model manager.

At 360, the model manager obtains a current predicted item identifier for the item from the certain head model 115 based on the current seed vector obtained at 350, the current candidate item identifier, and the certain localized metadata 116. At 370, the model manager receives an actual identifier from the terminal 120.

At 380, the model manager updates the certain localized metadata 116 of the certain head model 115 with the actual item identifier when the current predicted item identifier does not match the actual item identifier. This essentially modifies the training of the certain head model 115 such that if a same seed vector were to be provided a next time to the certain head model 115, the certain head model 115 would return the predicted item identifier as the actual item identifier.

In an embodiment, at 390, the model manager links the plurality of head models 115 to one or more hierarchies. Each hierarchy is traversable by the model manager to identify a given head model 115 and the corresponding localized metadata 116 based on given transaction information of any given transaction. The heuristics to traverse any given hierarchy is configurable.

In an embodiment, at 391, the model manager iterates to 330 for updated transaction information associated with additional transactions for a plurality of disparate stores. The additional transactions being performed on additional terminal 120 when produce items associated with PLU codes are entered by operators of the additional terminals 120.

In an embodiment, at 392, the model manager maintains statistical information in each localized metadata 116 for the corresponding head models 115. The statistical information is specific to one or more of retailers, stores of the retailers, departments of the stores, and customers of the stores.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner. Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving transaction information for a transaction, an item image for an item of the transaction, and a candidate item identifier for the item;
selecting a head machine learning model (MLM) from a plurality of head MLMs based at least on the transaction information;
obtaining an item classification data from a root MLM based on the item image;
obtaining a predicted item identifier for the item from the head MLM based on the candidate item identifier, the item classification data, and localized metadata for the head MLM; and
receiving an actual item identifier for the item and updating the actual item identifier and the item classification data in the localized metadata of the head MLM.

2. The method of claim 1 further comprising:
maintaining the localized metadata with statistics relevant to sales of a store, department of a store, and customers of the store.

3. The method of claim 1 further comprising:
maintaining and updating the localized metadata without any manual intervention.

4. The method of claim 1, wherein receiving the transaction information further includes receiving at least the transaction information and the candidate item identifier from a transaction terminal that is performing the transaction.

5. The method of claim 1, wherein selecting further includes identifying a retailer, a store of the retailer, and a geographic region for the store based on a terminal identifier provided in the transaction information.

6. The method of claim 5, wherein selecting further includes traversing a hierarchy linked to the plurality of head MLMs using the transaction information, the retailer, the store, and the geographic region to identify the head MLM.

7. The method of claim 1, wherein selecting further includes selecting the head MLM based on a customer identifier for a customer provided in the transaction information.

8. The method of claim 1, wherein selecting further includes selecting the head MLM based on a store identifier for a store provided in the transaction information.

9. The method of claim 1, wherein obtaining the predicted item identifier further includes providing the item classification data as a seed item classification vector produced by the root MLM based on the item image.

10. The method of claim 1, wherein obtaining the predicted item identifier further includes providing the predicted item identifier as a price lookup (PLU) code to a transaction terminal that is performing the transaction, wherein the item is a produce item.

11. A method, comprising:
training a root machine learning model (MLM) on item images for items to produce item classification feature vectors as seed vectors;
training a plurality of head MLMs on candidate item identifiers, seed vectors, and localized metadata specific to each of the head MLMs to produce predicted item identifiers;
receiving transaction information for a transaction being performed at a terminal, a current candidate item identifier for an item of the transaction, and a current item image for the item;
selecting a certain head MLM based on at least the transaction information;
obtaining a current seed vector for the current item image from the root MLM;
obtaining a current predicted item identifier for the item from the certain head MLM based on the current seed vector, the current candidate item identifier, and certain localized metadata;
receiving an actual item identifier for the item from the terminal; and
updating the certain localized metadata of the certain head MLM with the actual item identifier when the current predicted item identifier does not match the actual item identifier.

12. The method of claim 11 further comprising:
linking the plurality of head MLMs to one or more hierarchies, each hierarchy traversable to identify a given head MLM and corresponding localized metadata based on given transaction information of a given transaction.

13. The method of claim 11 further comprising:
iterating to the receiving of the transaction information for updated transaction information associated with additional transactions for a plurality of stores being performed on additional terminals when produce items are associated with price lookup (PLU) codes entered by operators of the additional terminals.

14. The method of claim 11 further comprising:
maintaining statistical information in each localized metadata for corresponding head MLMs, wherein the statistical information is specific to one or more of retailers, stores of the retailers, departments of the stores, and customers of the stores.

15. The method of claim 11, wherein training the root MLM further includes training the root MLM to produce the seed vectors as images features from corresponding item images along with probabilities that the corresponding image features are associated with a given coarse grain item classification.

16. The method of claim 11, wherein selecting further includes selecting the certain head MLM based on a customer identifier provided in the transaction information.

17. The method of claim 11, wherein selecting further includes selecting the certain head MLM based on a store identifier provided in the transaction information.

18. The method of claim 11, wherein selecting further includes selecting the certain head MLM based on a department identifier for a store provided in the transaction information.

19. A system, comprising:
at least one server comprising at least one processor and a non-transitory computer-readable storage medium;
the non-transitory computer-readable storage medium comprising executable instructions; and
the executable instructions when executed by at least one processor cause the at least one processor to perform operations, comprising:
receiving, from a transaction terminal, transaction information for a transaction, an item image for an item of the transaction, and a candidate item identifier for the item;
selecting a head machine learning model (MLM) from a plurality of head MLM based at least on the transaction information;
providing the item image to a root MLM;
receiving item classification data for a coarse grained item classification determined by the root MLM from the item image;
providing the candidate item identifier and the item classification data to the head MLM;
receiving a predicted item identifier from the head MLM based on localized metadata processed by the head MLM using the candidate item identifier and the item classification data;
providing the predicted item identifier to the transaction terminal;
receiving an actual item identifier for the item from the transaction terminal; and
updating the localized metadata processed by the head MLM with the item classification data and the actual item identifier.

20. The system of claim 19, wherein the transaction terminal is a self-service terminal operated by a customer during the transaction or the transaction terminal is a point-of-sale terminal operated by a cashier on behalf of the customer during the transaction.
